(19) United States
(12) Patent Application Publication
(10) Pub. No.: US 2019/0279240 A1
(43) Pub. Date: Sep. 12, 2019

(54) WEB CONTENT GENERATION AND STORAGE VIA BLOCKCHAIN

(71) Applicant: Joseph DiTomaso, New York, NY (US)

(72) Inventor: Joseph DiTomaso, New York, NY (US)

(21) Appl. No.: 16/288,638

(22) Filed: Feb. 28, 2019

Related U.S. Application Data
(60) Provisional application No. 62/641,488, filed on Mar. 12, 2018.

(51) Int. Cl. G06Q 30/02; G06F 16/23; G06F 16/22

(52) U.S. Cl. CPC G06Q 30/0217; G06F 16/2255; G06F 16/2379

(57) ABSTRACT

Provided are systems and methods for mining a website based on user-generated content. In one example, a method includes one or more of detecting user-generated content which has been added to a website via a user device accessing the website through a connection to a host server of the web site, transmitting a storage request comprising a hash of the user-generated content, receiving a data block comprising an entry which includes the hash of the detected user-generated content and an identification value of the user-generated content, and storing the received data block in a hash-linked chain of data blocks.

### CROSS-REFERENCE TO RELATED APPLICATIONS

This application claims the benefit under 35 USC § 119(e) of U.S. Provisional Patent Application No. 62/641,488, filed on Mar. 12, 2018, the entire disclosure of which is incorporated herein by reference for all purposes.

### BACKGROUND

User-generated content is a form of content that is created by users of a system and that is made available via a public platform such as a website, a mobile application, an e-commerce platform, a virtual storefront, and the like. User-generated content may range from simple text comments to more detailed video, audio, and images. For web resources such as comparison sites, social networking sites, e-commerce, search engines, and the like, user-generated content is critical in providing value. For example, reviews of a vacation rental posted on a travel website can provide a reader with significant first-hand perspective of the vacation rental beyond the simple price, location, and staged photos initially listed by the website. The value may also be provided in other ways beyond just travel related content such as restaurant reviews on Yelp, product reviews on Amazon, comments or up voting or down voting on sites like Reddit, adding data, information and knowledge on sites such as Wikipedia, and the like. Here, the user-generated content is often unsolicited content that lacks bias, providing readers with an honest, true and real-time assessment. Furthermore, as more user-generated content is added, the value to the website may further increase. This is usually associated traffic, and user engagement, time on site, distribution and sharing of content through the user's own personal channels.

The problem with user-generated content is that it takes time to develop as users slowly begin to visit and provide traffic to a website. Initially, the website may have no user-generated content making it less desirable. Furthermore, users do not receive any benefit from the value they are adding by generating and storing content on the website.

### SUMMARY

According to an aspect of an example embodiment, provided is a website mining system in which a user can supply web-based content to a website, and receive a value (e.g., a token, etc.) based thereon. The website may be hosted by a platform that connects to a blockchain network. The user-generated content (e.g., a unique ID, user ID, timestamp, etc.) may be stored via the blockchain to create an immutable record of the content. When the user has generated enough content, a digital token (e.g., coin, etc.) may be released to a user's account. A record of the transaction may also be stored on the blockchain. Furthermore, the value may be exchanged for other forms of value via the blockchain.

User-generated content can be value that is created and which provides contribution to the Internet. User-generated content may be viewer/user content that is added to an existing website such as review content, rating content, posts, etc. The user-generated content may be added with respect to already posted web content on the website such as web listings, job listings, reviews, and the like. Here, the user-generated content may be related to the web listing because it may include content that further describes, visualizes, or adds value to a web listing that has been posted on a website. User-generated content is different from the content created and added by developers of the website. The developers may initially create web postings which are internal to the website (and not modifiable by a viewer/user of the website). Meanwhile, the user-generated content may refer to content which is added to predefined areas of the website where active users of the site can store additional (supplemental) information associated with an embedded web listing such as review content, ratings, and the like. The supplemental information may be added into predefined fields, buttons, rating scores, thumbs-up, thumbs-down, and the like.

Examples of user-generated content include text, images, videos, audio, and the like, which can be posted on an online source such as a website, an application, etc. A digital token (or other item of value) may be released to a user in exchange for value created in the website. A user interface may output an indication of the initiated transfer of the released digital token for display. Although some of the examples herein describe that a token is earned by providing user-generated content, the embodiments are not limited to content such as text, images, and video being posted on a website but may be any value creation and contribution—to the internet—by the user such as a rating, an emotion, a vote, a thumbs up or a thumb down, and the like. Furthermore, in some cases the token (such as a digital coin) provided to the user in response to the value creation can be backed by ownership in the company and in some cases not the token is not backed by ownership in the company but available for exchange of cash, items, etc.

The example embodiments may be implemented using different types of tokens (or coins) including a utility token and a security token. As described herein, the utility token is an exchange of equity/ownership in a web site where content is being user-generated, and the user receives a coin that represents some sort of interest in the web site (or the underlying entity that owns the web site). In the other example of the security token, the user receives money or value directly for their user-generated content and does not receive equity or ownership in the web site.

According to an aspect of another example embodiments, the system may include a storage configured to store web content from a plurality of web sites, a network interface configured to receive, from a computing device, user-generated content (e.g., text, images, video, and any other type of value creation—this may include “up voting” or “down voting of content”, images added via a mobile platform, like Instagram, but in this case you would be “compensated” for your contribution, etc.) in association with an active web listing of a host website, and a processor configured to scan the web content from the plurality of websites stored in the database and determine whether the user-generated content has already been displayed via another website based on the scan of web content from the plurality of websites stored in the database.

In some embodiments, in response to determining that the user-generated content has not been previously displayed via another website, the processor is further configured to release a previously stored digital token from a plurality of digital tokens associated with the host website, and initiate a transfer of the released digital token to a user account associated with the user-generated content, wherein the released digital token is configured to be exchanged for value in the host website. In some embodiments, the determination of what value is being added/created may depend upon several factors, including the uniqueness and originality of the content and contribution that was produced/created.

Other features and aspects may be apparent from the following detailed description, the drawings, and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a website mining system in accordance with an example embodiment.

FIGS. 2A-2C are diagrams illustrating a process of mining a website for digital tokens in accordance with example embodiments.

FIG. 3 is a diagram illustrating a blockchain transaction process based on user-generated content in accordance with an example embodiment.

FIG. 4 is a diagram illustrating a process of tracking and determining an originality of user-generated content in accordance with an example embodiment.

FIG. 5 is a diagram illustrating one example of a computing system in accordance with example embodiments.

FIG. 6A is a diagram illustrating a process of storing intrinsic and extrinsic values of content via a blockchain, in accordance with an example embodiment.

FIG. 6B is a diagram illustrating processes for determining intrinsic and extrinsic values for content, in accordance with an example embodiment.

FIG. 7 is a diagram illustrating a method of storing user-generated content via a blockchain, in accordance with an example embodiment.

FIG. 8 is a diagram illustrating a method of storing a value for user-generated content via a blockchain, in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a website gamification and monetization system that enables a user to mine a website by providing user-generated content and uncover coins (or other sources of value) as the user interacts with and produces content with respect to the website. User-generated content provides meaningful and authentic content that has separate value in addition to the originally posted content of the website. The example embodiments provide a system that tracks and controls the release of digital tokens (such as coins) to users as the enter and post content on the website. The gamification system can be associated with or otherwise control a distributed ledger such as a blockchain, where user-generated content (or confirmation thereof) can be exchanged or otherwise converted to value (such as digital coins) using blockchain transactions to create and update the distributed ledger. Furthermore, the blockchain may also provide a forum where users can trade, sell, or otherwise exchange their digital coins for items and money.

The example embodiments also provide the ability to track and analyze the user-generated content being posted to determine how authentic the content truly is. The system can crawl or otherwise scan the Internet and other related sites to determine that the content being posted by the user is truly original. The exchange of value for the user-generated content can be conditioned on how original/unique the system determines the content to be. In addition, the example embodiments also provide for a valuation of the content to be determined based on one or more intrinsic properties of the content such as an amount of words used, a type of content (images, videos, text, etc.), attributes of the user (expert user versus novice user, etc.), and the like. In some embodiments, the value may also be “up votes”, “down votes”, “likes”, “dislikes”, “favorites”, “love” etc. In some embodiments, the created value may be measured in traffic generation, backlinks, sharing through their own social channels, do what they do to generate traffic to the site. Another aspect used to determine the value is up votes and down votes, but also time the consumers of the value/content remain on site, engage with the content, share the content, back-link to the content, etc.

The internet is full of content. Content can take many forms—images, videos, written comments (a few words or sentences), long form content like articles or stories (250 to 10,000 words or more). In some cases, this content is created or manufactured by the company itself. For example, a journalist at the N.Y. Times is hired and compensated for an article he/she writes and publishes. This article (content) is then published and available on line, where anyone with access to the internet can locate and read (consume) the article or content. This written content produces traffic, sessions or visitors. These are individuals who traffic and visit the page to consume the written content. This content is also ranked by search engine algorithms. Ranking is based upon the uniqueness of the content, length, number of visitors, number and quality of back-links, time individuals spend on the page and number of other factors.

Content can also be created by individuals, people who are users and consumers of the internet. Again, this content can take several forms—short-form, long-form, images, videos, short posts or tweets. The following are a few examples of internet user and consumer generated content.

Facebook—Content is created via consumers who login and provide their personal information, upload images, pictures, videos and write short tweets or posts. They also re-share their posts and create their own independent network via connecting with friends and family who also have their personal content posted online.

Yelp—Content is created by consumers who write reviews and write about their experience interacting and using the services from a local businesses like a dentists, hair stylists, mechanics, restaurants, night club.

Amazon—Content is created by consumers who write reviews, upload images or videos and provide star ratings regarding a particular consumer related product or good (clothes, electronics, books, appliances, beauty products, pet supplies, office products, musical instruments, sports and outdoor equipment, etc.)

TripAdvisor—Content is created by consumers who write reviews, up load images, videos, provide start ratings, etc. regarding their recent travels or recent stay at a hotel.

Twitter—Content is created by consumers who write small short sentences (“tweets”, less than [100] words and share this information via their social network and community. Images, personal information, URLs and other tweets can also be shared.

Airbnb—Content is created by i) owners who own the individual properties, upload images, property descriptions, location information, address etc. ii) individuals who stay at a listing, a property, a vacation rental while or after traveling and write a review after they have stayed at the location/property, iii) hosts, owners of the property writing a review about the person who stayed at the vacation rental or property, iv) reviews regarding experience, v) experience related content.

Reddit—Content on Reddit is created and published by the users and involves the creation of questions or posts and the posts are then up-ranked or down-ranked depending upon whether or not readers like the content that is being posted. [Reddit bridges communities and individuals with ideas, the latest digital trends, and breaking news. Their mission is to help people discover places where they can be their true selves, and empower the community to flourish.]

Quora—Content is created by visitors/users who post questions and visitors to answer these questions. [Quora's mission is to share and grow the world's knowledge. A vast amount of the knowledge that would be valuable to many people is currently only available to a few—either locked in people's heads, or only accessible to select groups. We want to connect the people who have knowledge to the people who need it, to bring together people with different perspectives so they can understand each other better, and to empower everyone to share their knowledge for the benefit of the rest of the world.]

Wikipedia—Content is created by visitors and the overall community at large. These are individuals who visit the site and voluntarily create content, information about any subject, could be war, ants, bridges, history, the universe, anything about anything. This is essentially an on-line encyclopedia where all of the content is created, updated and managed by visitors to the site. Anyone can add content, information, images regarding any subject. All of the information is created and managed by visitors, consumers, who visit the site. Wikipedia is written collaboratively by largely anonymous volunteers who write without pay. Anyone with Internet access can write and make changes to Wikipedia articles, except in limited cases where editing is restricted to prevent disruption or vandalism. Users can contribute anonymously, under a pseudonym, or, if they choose to, with their real identity.

All of these examples are what is classified as user-generated content. This content can take many forms but is content that can be produced, created and posted by visitors, the same community that traffics and visits the site, bloggers, professional journalist, moms, pops, essentially anyone that wants to contribute and add value or add information or add content to the community/website/page. All of this content on all of these site (Facebook, Yelp, Amazon, TripAdvisor, Airbnb, Twitter, Quora, Reddit, Wikipedia) is created for free. Contributors and creators of content on these sites and throughout the interne are not compensated in any way for the creation of this. The purpose and motivation to create this content is purely organic, out of the goodness of their heart, a platform to have a voice, a reason to contribute to the community. Individuals are not compensated, not provided with any value, not provided with any ownership in the business. All of the user generated content that is created on all of these sites is created for free. Individuals can spend hours out of their day, days out of the year, creating, posting and uploading content to these sites. Hours, time and energy that they are not compensated for.

The example embodiments explore the concept of “What if users who create content were compensated, and what if the compensation was in the form of a coin (or some other form of digital asset) capable of being exchanged in an open market (security coin) and/or exchanged for other items (security coin), or in exchange for equity/value in the company (utility coin).

Web listings are often used to represent an item such as a product or service that is offered for sale. For example, the item may refer to a lodging accommodation (e.g., a hotel room, a vacation home rental, a train cabin, a cruise cabin, etc.), an airplane ticket, a consumer good, a service to be performed, and the like. Web listings may include digital content such as images, textual description, input fields, boxes, tabs, other selections, and the like. A comparison website or a search engine provides an aggregate of search results or a comparison of web content (e.g., price, criteria, availability, description, images, etc.) for a same product (and brand) from across multiple web sources.

For example, a comparison website host server may receive search results corresponding to a same rental property (e.g., lodging) from multiple website and consolidate the search results into a single search result for that accommodation rental property which provides a comparison of different content such as price, features, availability, and the like. As another example, the comparison site may only extract some content from a plurality of search results corresponding to the same item from across multiple websites (e.g., price for an item on multiple sites, availability of item from multiple sites, etc.) while eliminating the rest of the content.

When a web listing has gone “live” and is available for viewing via a web address (URL) on the Internet, oftentimes the website will make the content interactive so that a user can upload or otherwise add user-generated content to the web listing such as a user review, a rating, a post, a blog, an image, a video, an audio, and the like. The user-generated content may create additional and genuine value to the website because it provides additional information beyond the initial content and can be of use to another user on the website who is looking at the same or a similar listing. Oftentimes, the user-generated content is more beneficial than the original content because it provides a non-biased and first-hand account or review of the item or service represented by the web listing.

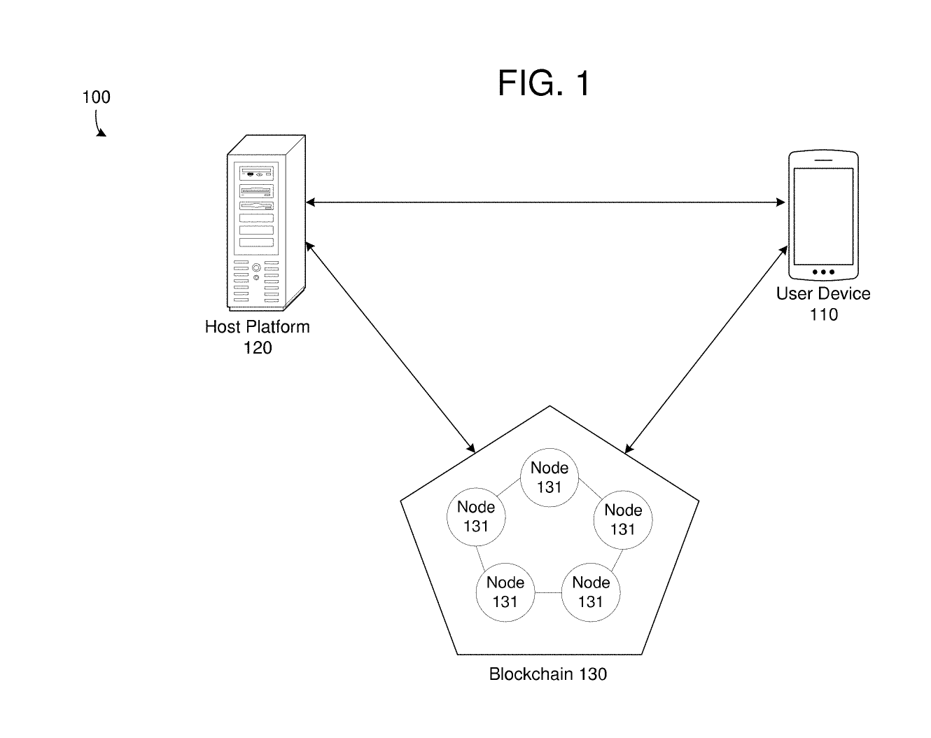

FIG. 1 illustrates a website mining system 100 in accordance with an example embodiment. Referring to FIG. 1, the system 100 includes a user device 110 (e.g., a smart phone, a tablet, a personal computer, a laptop, a smart-wearable device, an appliance, a kiosk, a television, and the like. The system 100 further includes a host platform 120 (e.g., a web server, a cloud platform, a database, a desktop, etc.) configured to host a website such as a search engine comparison site. The system 100 also includes a blockchain 130 which includes a network of nodes 131 which implement a blockchain ledger capable of storing an immutable hashed chain of data blocks. According to various embodiments, the blockchain 130 may be used to execute and store transactions which include the exchange of digital currency for user-generated content. The digital currency may represent a stake, an equity, an interest, etc., in the website hosted by the host platform 120. The user device 110, the host platform 120, and the blockchain 130 may be connected to each other via a network such as the Internet, a private network, and/or the like.

In operation, a user of the user device 110 may execute a web browser and traverse to a website or install a mobile application that is hosted by the host platform 120. The user may interact with the web site and submit or otherwise post post user-generated content to the website. The user may login and create an account that enables them to receive tokens or other value based on value creation for the website. The user-generated content can include a user review, a blog, a tweet, a message, photos, videos, ratings, and the like, which are made publicly available by posting the user-generated content to a live website, up votes, down votes, etc. The website may include a plurality of web listings related to items of value that can be purchased or otherwise exchanged. The user-generated content may provide value to the website by posting additional information such as first-hand unbiased reviews of a product, a service, a hotel room, etc., represented by the web listing. When a user posts content to the website, the host platform 120 may determine a value associated with the user-generated content and initiate a transfer of equity-backed digital assets to a user account associated with the user device 110. As an example, the digital asset may be a token such as a coin, a digital currency, or the like.

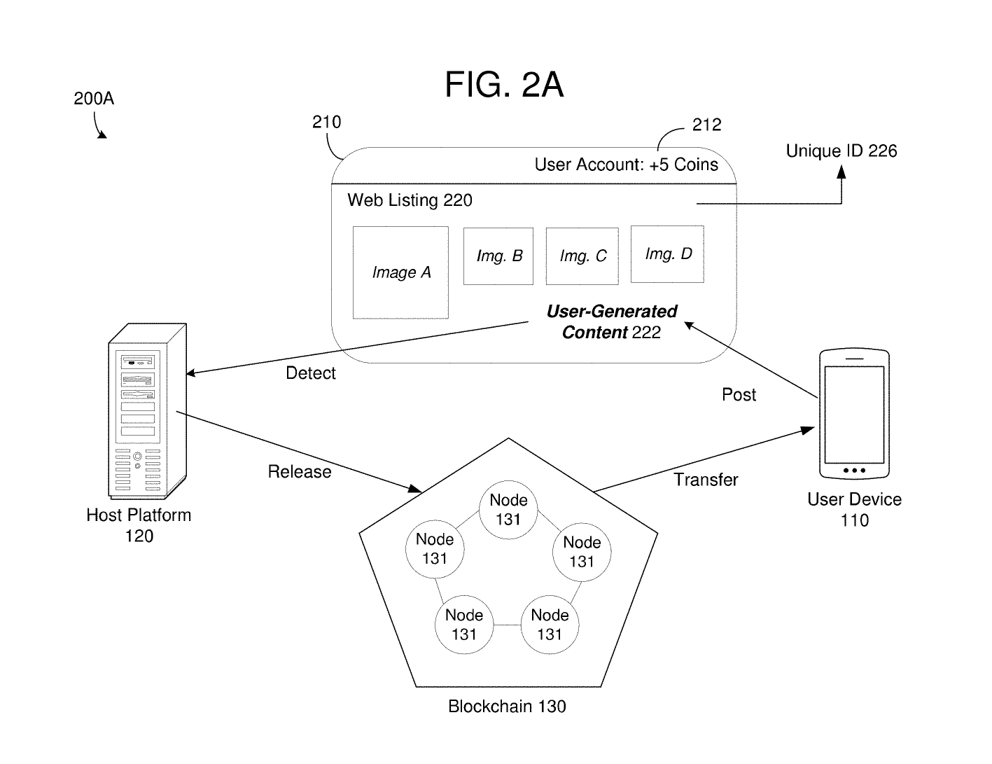

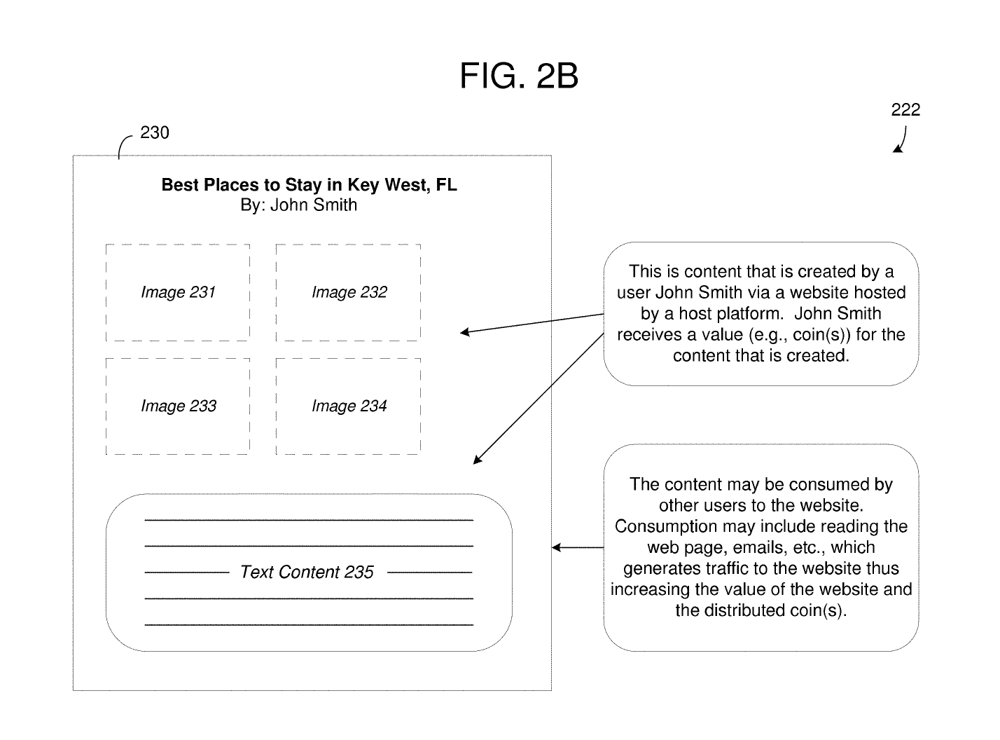

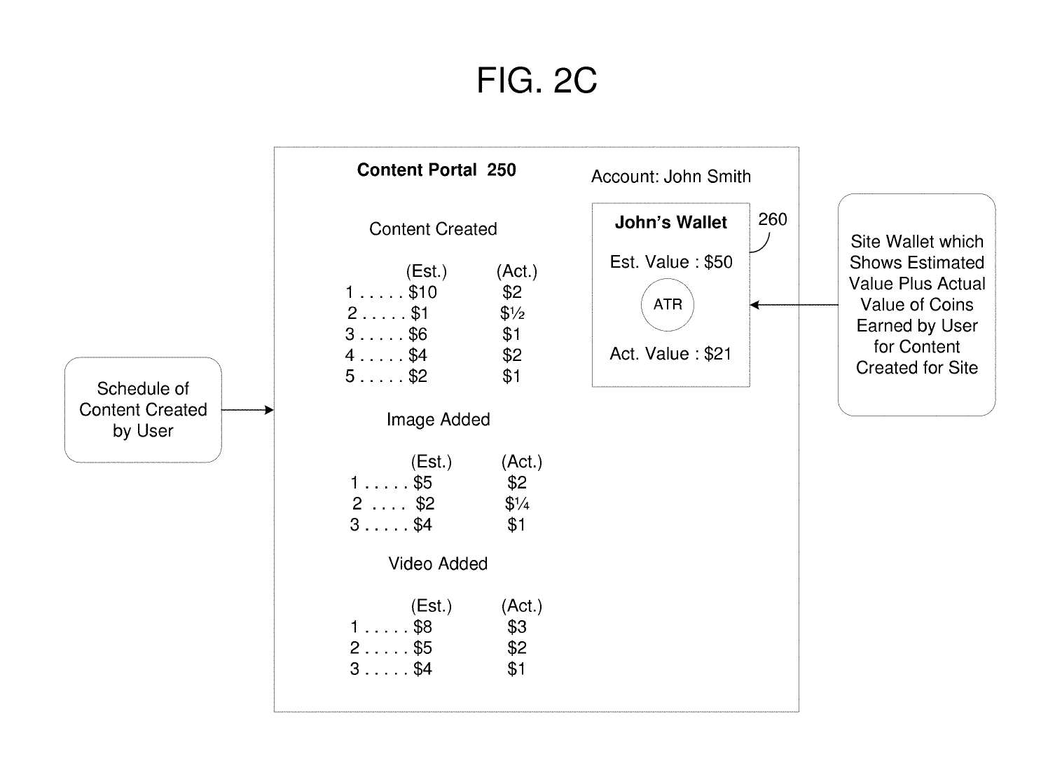

FIGS. 2A-2C illustrate a process of mining a web site for digital tokens in accordance with example embodiments. Referring to FIG. 2A, a process 200A of mining digital coins is described and shown. Here, the system 100 of FIG. 1 is shown as implementing the process 200A, but it should be appreciated that the embodiments are not limited thereto. For example, a different system and devices may perform the methods and processes described herein. In addition, the embodiments are not limited to the blockchain 130 for transferring digital coins based on user generated content but may include another system such as another type of distributed ledger, or the like.

Referring to FIG. 2A, host platform 120 hosts a website 210 which includes a web listing 220 being interacted with by user device 110. For example, the user device 110 may post user-generated content 222 to the web listing 220 of the website 210. In this example, the host platform 120 may store a plurality of digital tokens of value in the website 210 which can be transferred via blockchain 130. The user device 110 may post the user generated content 222 (such as shown in the example of FIG. 2B), and the host platform 120 may detect a mining operation being performed via the website. Referring to FIG. 2B, the user generated content 222 is shown as a post 230 which includes images 231-234 and text content 235 posted by the user John Smith.

In this example, the mining operation may include the user-generated content 222 being added to the active website 210 by the user of the user device 110 via a network. In response to detecting the user-generated content being added, the host platform 120 may release a previously stored digital token from the plurality of digital tokens in response to the mining operation being detected, and initiating transfer of the released digital token to a user account associated with the user-generated content via the blockchain 130. In some embodiments, the host platform 120 may also output notification of the initiated transfer for display via a user interface (such as shown in FIG. 2C) displayed on the user device 110 while the user is interacting with the website. The user-generated content (e.g., the images 231-234, the text content 235, etc.) are added to a web listing 220.

Referring again to FIG. 2A, the web listing 220 and the user-generated content 222 may have a unique ID 226 which identifies both the web listing 220 and the user-generated content. In other words, the unique ID 226 may be associated with a pair of data items, for example, the user-generated content, and the embedded web content that the user-generated content is associated with. The system may identify a page, a URL, etc., of the web content, and identify a document name, document ID, text-box ID, timestamp, etc. of the user-generated content, and generate a hash value which is the unique ID 226. As another example, the unique ID 226 may be a random number, or some other identifier (alphanumeric characters, etc.) which the system generates as a way of uniquely identifying the embedded content and the user-generated content that is being added (supplemented) thereto. The unique ID 226 may be used to identify the user-generated content with respect to the web posting on the website when the data is stored on the blockchain 130.

According to various embodiments, the released digital token or tokens may be exchanged for value in the website (or other value). The value may include equity, stock, ownership, or the like, in the website and may be backed by assets such as cash, gold, property, and the like, which may be held in a third-party escrow (or can be held on to for exchange or purchase of other goods and services, exchanged for gif cards or other items of value, sold on a secondary exchange, etc.) In some embodiments, the plurality of digital tokens may include a plurality of digital coins, and the releasing may include releasing a previously stored digital coin to the user account associated with the user-generated content. Here, the coin may be transferred via a blockchain transaction executed and committed to blockchain 130 via the blockchain nodes 131. When the coins are transferred, a notification may be displayed as shown in this example by reference numeral 212.

In the examples, the concept of content mining involves the creation of content and media (or any other value—thoughts, ideas, expressions, images, emotions created by the user) that is posted and distributed online. There is an argument that this media and content belongs to the actual induvial and the folks that create it should be the owners of purveyors of the media which they create. The definition of content could be written content (long and short form), images, videos anything that is produced by an individual. This could be any general form of expression created by an individual. For example, assume that a person lives 85 years. During the life span of their life they consume and produce. For what they consume, they pay. If they go out to a restaurant and eat, if they purchase groceries, watch a movie, consume media (in some cases the media is paid for by advertisers). When they themselves produce and create, they themselves are paid by the employer that then controls and owns the content. When a writer produces a book, they are the owner of the content that they produce and that content is then packaged and distributed via a publicist and seller. When a photographer takes a picture or an artist paints a picture, they are the owners of the content that they themselves created. They themselves can decide what to do with this content. They can keep it or sell the content that they created.

However, when someone goes to the Internet and produces or creates content, the content creator is never compensated, but there is value. The value is immediately taken from them, or otherwise captured from them and utilized by the owners of the website (equity owners). There is value which is taken from them and used to profit the website. According to various aspects, when any form of content is created and posted (shared) the consumer can be properly compensated with a coin providing equity in the website where the content is added.

The mining process entails coming to alltherooms.com (or a website), where the customer may login. By logging in the customer can provide their first name, last name, email address and any other information about themselves that may be valuable (picture of themselves, date of birth, bank or credit card details, phone number). A website wallet 250 as shown in FIG. 2C may then be created and may be displayed. Also, each time a user adds user-generated content a content portal 250 can illustrate a schedule of value that has been created by the user (John Smith) based on their content added to the website. The wallet 250 may store value that has been transferred or is otherwise held by the customers. The wallet 250 may include a box or some other digital representation that appears in a corner of the screen containing the value of customer's wallet. Steps involved in the mining process shown in FIGS. 2A-2C may include the following:
1—Customer log's in and creates an account
2—Once the customer has logged in the wallet becomes active
3—The customer/user can then begin creating content (or mining the site) depending on the type of content (10 word post, 1,000 word story, image, video, like, dislike, up-vote, down-vote, any form of interaction or contribution) the content creator will be assigned a fraction of a coin, a coin, or multiple coins depending upon the value of the information that is being posted to the site. In some embodiments, the content may be qualified before the coin(s) is released to the customer/user. The qualification may be an originality check on the content which can determine whether the content has been posted anywhere else on the Internet.
4—The customer (content creator) will first be assigned an “estimated number of coins” this would based upon the value (type and number content that is produced). Different types of content (e.g., text, image, audio, video, etc.) may receive different types of value. Also, the same type of content may receive different values based on a quality of the content, an originality of the content, a uniqueness of the content, an authenticity of the content, and the like. In some cases, if a user is an expert user vs. a novice user of the site, the expert user may receive more value for the same content in comparison to the novice user. As a non-limiting example:
1 image=⅛ of a coin
5 images=1 coin
10 words of written content= 1/10 coin
1,000 words of written content=3 coins
10 second video=1 coin
30 second video=5 coins
etc.
Once the content has been verified/tracked that is has not been copied or taken from another site (i.e., the content is authentic and original), then the “estimated coin value” will be transformed into “actual coins” which the customer can utilize as needed.
5—Coins can also be assign by traffic generated by the content (time the consumers reading the content stay on site) that was created by the consumer. If a certain image, set of images, written content or videos is posted and generates a certain amount of traffic the user may also be compensated with a coin. The number of coins will correlate with the volume and consistent volume of traffic generated.
100 visitors per day= 1/10 coin
1,000 visitors per day=1 coin
10,000 visitors per day=10 coins
etc.
6—the coins themselves can be used to purchase items on the site, purchase other items off site, exchanged for cash or potentially hold an ownership in the company.
7—Coins can also be earned by Click through, referrals, logging in for the first time, referring other customers, writing reviews (for hotels or vacation rentals), listing properties on the site (hotel, vacation rentals) etc.

Click through—this would entail providing the customer with a coin every time they are referred to another site. This would be when they click the “visit deal” button on alltherooms.com and they are referred to another site like booking.com, expedia.com, etc. where they would book their room. We would pay the customer for a qualified lead.

Logging in for the first time—When a customer comes to the site for the first time and creates an account and provides all of their personal details they will earn a coin.

Customer referral—When an existing customer refers another customer and that customer results in a qualified new customer the customer that referred the new customer will be given a coin. The new customer will also be given a coin.

Writing review (e.g., hotel or vacation rental)—When reviews (content) are created on the site and that content is written for.

Listing a property (e.g., hotel or vacation rental)—Coins can also be given when individuals actually list their property (hotel or vacation rental) on alltherooms.com. This would be similar to hotels listing their hotels on expedia.com or booking.com, or similar to individuals listing their home on Airbnb or any of the other vacation rental sites.

Other—Coins can be giving any time content is created on alltherooms.com, this could be restaurant reviews, night club reviews, city, destinations, experiences, property reviews, hotel reviews. Wherever users and consumers are adding value, and creating value in any shape or form, the consumer can and will be properly compensated for the value that they have created. In some embodiments, the coins can be distributed based upon any interaction or any form of value add to the internet—likes, favorites, up votes, down votes, clicks, purchases of items, etc.

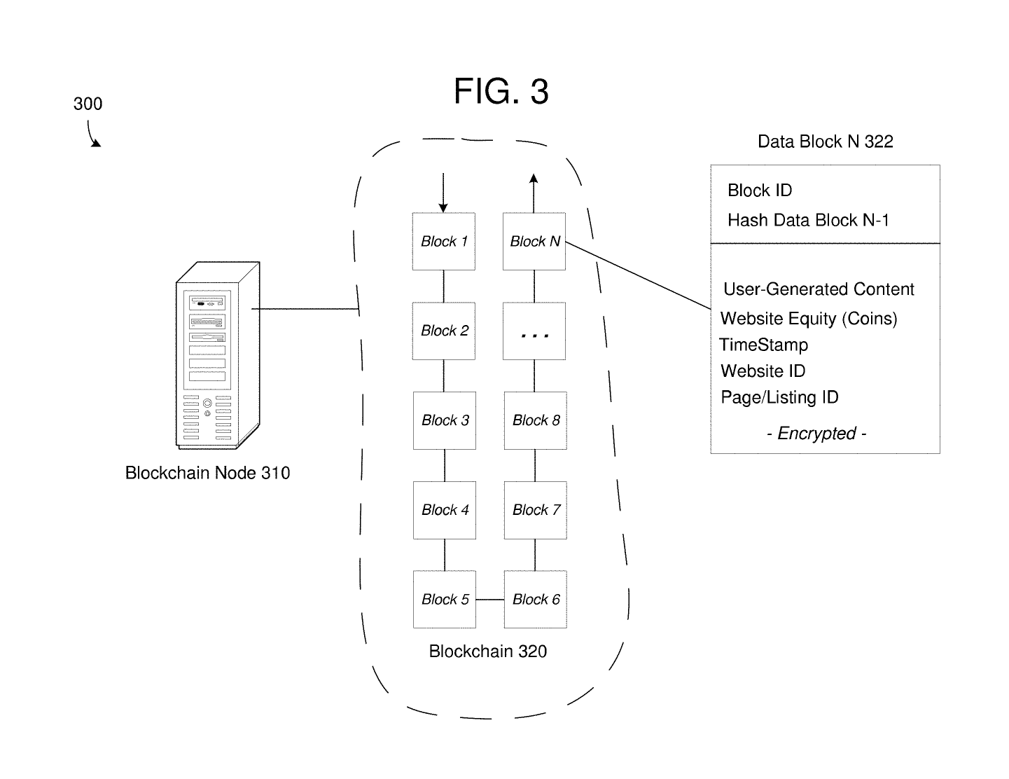

FIG. 3 illustrates a blockchain transaction process 300 performed based on user-generated content in accordance with an example embodiment. Referring to FIG. 3, a blockchain node 310 (which may correspond to a blockchain node 131 shown in FIG. 1) may manage and store a blockchain ledger 320 in which a plurality of data blocks are connected via a hashed-chain of links. For example, each time a coin or other digital value is transferred to a user who generates and adds content to a website, the blockchain may store a record of the transaction as well as the components involved in the transaction. Furthermore, the blockchain may also generate an immutable ledger by linking together the blocks by hashing data from a previous block in the chain and storing it in the header or some other portion of a current data block.

For example, the blockchain node 310 may receive a request for transferring a value from a website to a user in response to user-generated content being added to the website. In response, the blockchain node 310 may identify a position of the blockchain 320 for adding a data block. The blockchain 320 may be accessible to a plurality of blockchain nodes (including blockchain node 310) and the position may include a next link in the chain of blocks for adding a data block to the existing chain of blocks. In response, the blockchain node 310 may generate a new data block N 322 for the blockchain. For example, the new data block 322 may have stored therein an identification of the value being transferred from the website, an identification of the user-generated content, a hash of an immediately previous data block in the blockchain having stored therein an identification of a previously transferred value and previously generated user-generated content, a timestamp at which the transaction occurred, a block ID for the blockchain, a website ID (when the blockchain is associated with multiple websites, a listing/webpage ID, and the like. The blockchain node 310 may encrypt the new data block and store the encrypted new data block at the identified position of the blockchain.

In some embodiments the blockchain node 310 may broadcast the new data block 322 to a plurality of endorsing blockchain nodes and receive authorization to commit the new data block 322 to the blockchain 320 from a consensus (e.g., one or more as defined by a smart contract) of the plurality of the endorsing blockchain nodes, prior to storing the encrypted new data block. In some embodiments, the blockchain node 310 may transmit the new data block 322 to an organizing node of the blockchain for replicating/distributing the new data block 322 across a plurality of blockchain peers of the blockchain.

For example, a blockchain may be implemented for releasing or otherwise exchanging digital coins (or other forms of currency). The blockchain is a distributed system which can multiple types nodes that communicate with each other. Examples of types of blockchain nodes include peer nodes, endorsing nodes, organizing nodes, client nodes, and many others. A blockchain can execute or otherwise operate programs called chaincode (e.g., smart contracts, etc.), holds state and ledger data, and executes transactions. Some transactions are operations invoked on the chaincode. In general, blockchain transactions typically must be “endorsed” by certain blockchain members and only endorsed transactions may be committed to the blockchain and have an effect on the state thereof. Other transactions which are not endorsed can be disregarded. Some blockchains may include special or customized chaincodes for customized management functions, data access, communications, and the like.

The blockchain is implemented via an immutable ledger that can be replicated and stored across multiple nodes in the blockchain network. The ledger is a sequenced, tamper-resistant record of all state transitions of the blockchain. State transitions may result from chaincode invocations (i.e., transactions) submitted by participating nodes. A transaction may result in a set of asset key-value pairs being committed to the distributed ledger as one or more operands, such as creates, updates, deletes, and the like. The ledger includes a blockchain (also referred to as a chain) which is used to store an immutable, sequenced record in blocks. Some or all of the nodes within a blockchain network may maintain a copy of the ledger of each channel of which they are a member.

The chain is a transaction log which is structured as a sequence of hash-linked data blocks, where each data block may include a sequence of N transactions where N is equal to or greater than one. In the example embodiments herein, the transactions may be associated with the exchange of website value/equity for user-generated content. Accordingly, data blocks stored within the chain may include information identifying user-generated content, value provided on behalf of the website for the user-generated content, a hash value of a previous data block in the chain, and the like. In some embodiments, the block header may include a hash of the block's transactions, as well as a hash of the prior block's header. In this way, all transactions on the ledger may be sequenced and cryptographically linked together in an immutable fashion. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if need be) upon peer node startup, and before transactions are accepted.

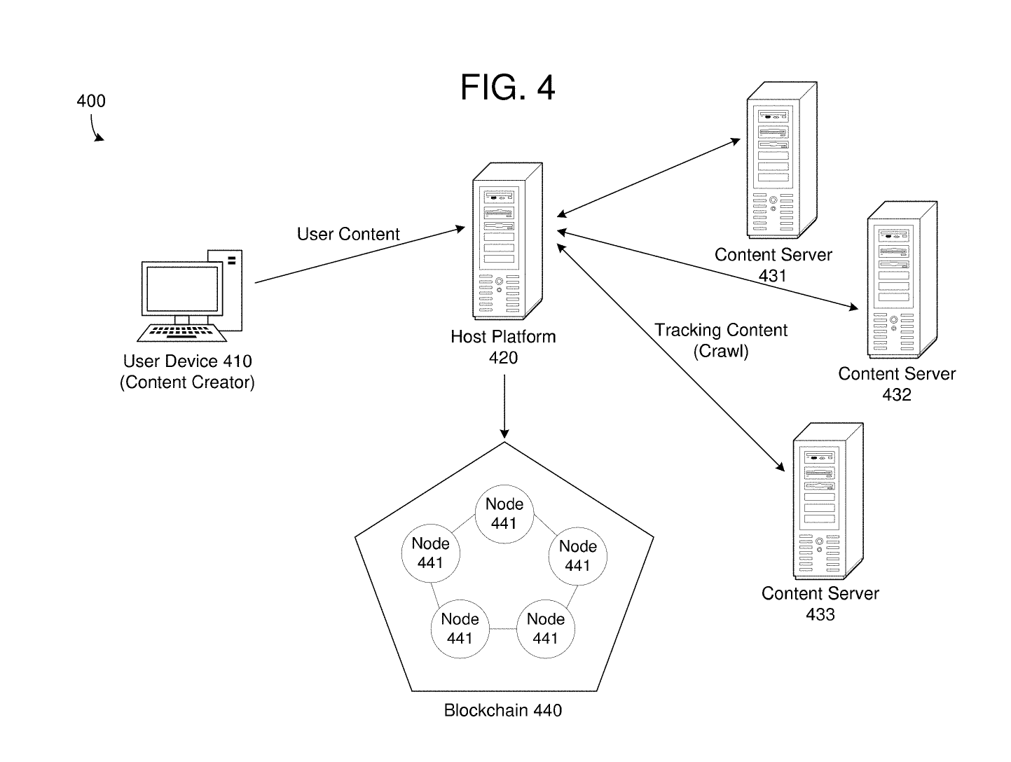

FIG. 4 illustrates a process 400 of tracking and determining an originality of user-generated content in accordance with an example embodiment. Referring to FIG. 4, a user device 410 may create content and add the content to a website that is hosted by host platform 420. In some embodiments, the host platform 420 may also include or otherwise have access to a crawl server or other type of web resource capable of crawling many different sites on the Internet stored by content servers 431, 432, 433, etc., in a search for user-generated content. The crawled data may be stored in a database that is part of the host platform 420 or accessible to the host platform 420. Accordingly, when a user-generated content is received by the host platform 420 from the user device 410, the host platform 420 may determine whether any other type of similar content exists and that is already posted on another site. If it is determined that the content is authentic (or otherwise not copied from another site), the host platform 420 can release a digital value to a user account associated with the user-generated content via a blockchain 440 implemented by a plurality of blockchain peer nodes 441.

For example, the host platform 420 may scan the web content extracted from or otherwise collected from a plurality of websites stored in the content servers 431, 432, and 433 (which may be crawled and stored locally or in a database associated with host platform 420) and determine whether the user-generated content has already been displayed via another website based on the scan of web content from the plurality of websites. In response to determining that the user-generated content has not been previously displayed via another website, the host platform 420 may release a previously stored digital token from a plurality of digital tokens associated with the host website, and initiate a transfer of the released digital token to a user account associated of the user device 410 that provided the user-generated content. Here, the released digital token may be a coin or other digital marker that can exchanged for value in the host web site.

In some embodiments, the user-generated content provided by the user device 410 may initially be posted to the website hosted by the host platform 420. In other words, the content may go live prior to determining whether to compensate the user for the value that they have provided and regardless of whether or not it is determined that the user-generated content has been previously displayed via another website. Subsequently, the host platform 420 may make a determination that the content is original/authentic (or a level of authenticity such as 75%) and determine whether or how much digital value to distribute to the user based on the originality.

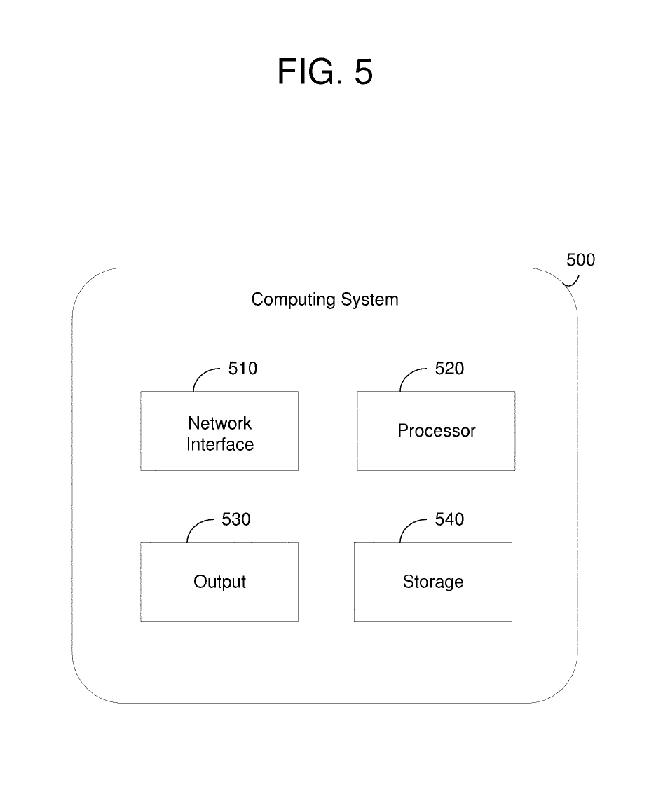

FIG. 5 illustrates a computing system 500 in accordance with example embodiments. For example, the computing system 500 may be a web server, a database, a cloud platform, a user device, a distributed computing system, and the like, as shown in any of the examples of FIGS. 1-4 above, and configured to perform any of the methods and devices as described herein. In some embodiments, the computing system 500 may be distributed across multiple devices. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, and the like.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. The output 530 may include a port, a cable, a wireless interface, or the like, capable of outputting (and in some cases inputting) data to and from the computing system 500. The storage device 540 is not limited to a particular storage device and may include any known memory device such as RAM, ROM, hard disk, and the like, and may or may not be included within the cloud environment. The storage 540 may store software modules or other instructions which can be executed by the processor 520 to perform the methods described herein.

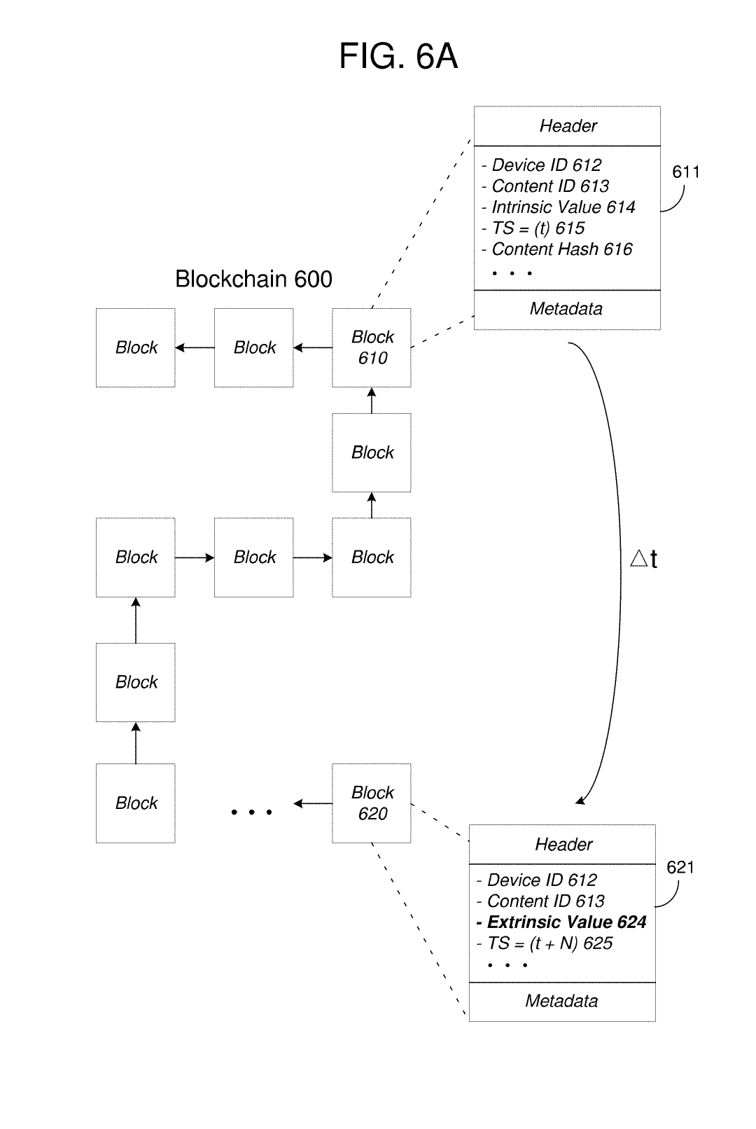

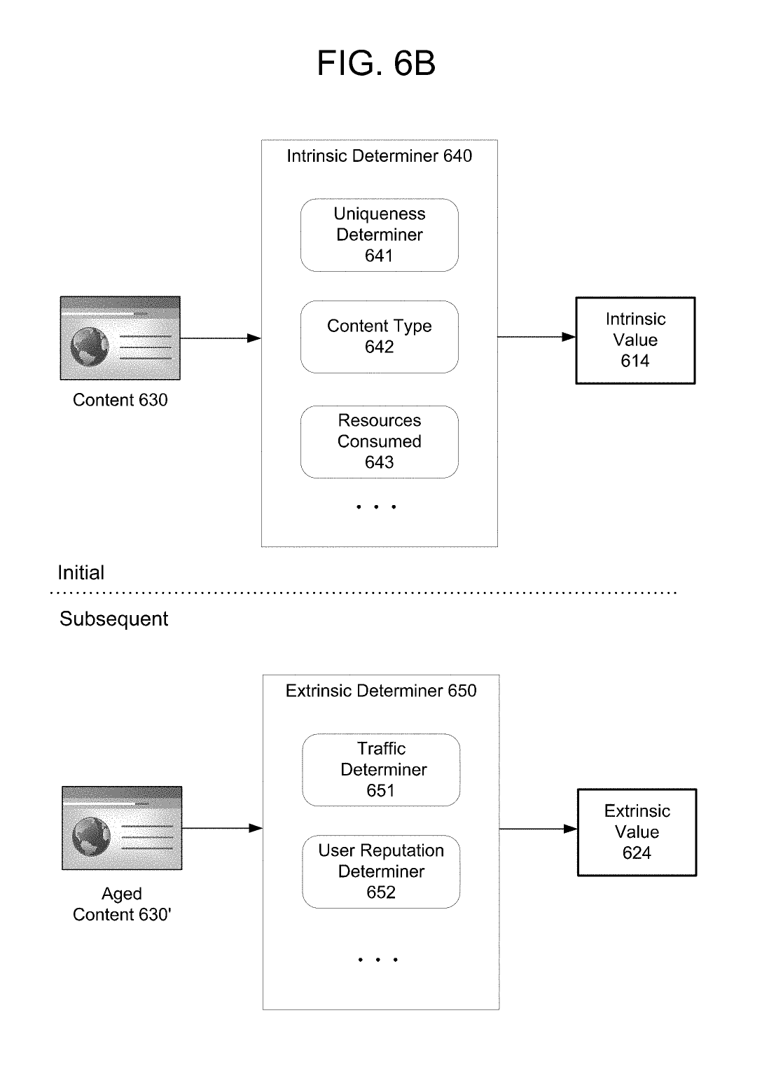

FIG. 6A illustrates a process of storing intrinsic and extrinsic values of content via a blockchain, in accordance with an example embodiment. Referring to FIG. 6A, a plurality of blocks are stored on a blockchain 600. The blockchain may be included within a distributed ledger that is an immutable record of transactions. Each block may maintain a link to a previous block in the chain such as by storing a hash value of a previous block. As a result, the blocks may be hash-linked together.

A data block may include various data storage areas include a header, a body, and a metadata portion. Any of these portions may be used to store information about the user-generated content and the value associated therewith as described herein. In the example of FIG. 6A, the body of the data block stores the user-generated content. For example, block 610 stores data of user-generated content via a body 611 of the data block. In this example, the body 611 stores an identifier 612 of the user that generated the content (e.g., a device ID) such as a IMEI, phone number, etc. As another example, the identifier 612 may be an email address, a username, a URL associated with the device, and the like. The identifier 612 may be an important aspect in determining a value for the user-generated content. For example, a user with a higher reputation (e.g., a greater peer review rating, a syndicated writer, a celebrity, etc.) may be given greater value for their web content than an unknown and/or new user, etc.

In addition, the system may also assign a unique ID 613 (or multiple unique IDs) to the content that is added to the website. The unique ID 613 may distinguish the user-generated content from other user-generated content which has been added to the website. In some embodiments, the unique ID 613 may also be associated with embedded content of the website such as a job posting, a vacation rental posting, etc., which are listed on the website by the website developers. Another example of the unique ID 613 is described with respect to FIG. 2A (unique ID 226).

According to various embodiments, the system may also determine a value for the user-generated content. An intrinsic value 614 may be determined by the host platform of the website based on various initial attributes of the user-generated content. Furthermore, a timestamp 615 may be added identifying when the user-generated content was added to the website. Also, a hash 616 of the content 630 may be created and stored within the block or it may be stored in an off-chain storage (not shown) and metadata of the storage location off-chain may be stored in the block 610. An example of determining intrinsic value 614 is shown in FIG. 6B. Referring to process 660A, the host platform may include an intrinsic determination module 640 which reads the user-generated content (content 630) which is newly added to the website and determines a uniqueness value of the generated content based on a uniqueness determiner 641.

The uniqueness value may be determined based on whether the content 630 has been posted anywhere else on the Internet. The host platform may crawl the interne (including thousands of sites) and store crawled content in servers/databases. When new content 630 is added to the website, the uniqueness determiner 641 may compare the content 630 to stored content to determine whether the content 630 is unique or whether it has already been uploaded on another site. Here, the uniqueness determiner 641 may perform a similarity analysis (e.g., text-analysis, image-analysis, etc.) to identify how unique the content 630 is to the Internet. If the content 630 is found on another site, the host platform can notify the user who created the content 630 and request them to take it down, or receive no value for the content 630 on the website. As another example, if the uniqueness determiner 641 determines that content 630 has been copied from another site, the host platform may not assign any value to the new content 630.

Other factors that may also influence the intrinsic value. For example, the intrinsic determination module 640 may include a content type determiner 642 which determines whether the content 630 is text, image, video, audio, etc., and a resources consumed module 643 which determines an amount of activity/effort associated with posting the content 630. For example, the resources consumed module 643 may estimate how much processor resources were consumed, how much time was spent by the user, how much cost it was to the user to create, etc. for generating the content 630. The intrinsic determination module 640 may use any of these attributes (e.g., uniqueness, content type, resources consumed, etc.) to determine the intrinsic value 614 for the new content 630.

Referring again to FIG. 6A, over time, the value of the content may change. This change in value may be referred to as extrinsic value. For example, the content may be such that it draws more visitors to a site, or otherwise grows in popularity over time (e.g., through user reputation, etc.). The system described herein may generate an extrinsic value 624 for the content after it has aged and store the extrinsic value 624 in a data block 620 on the blockchain 600. Similar to the intrinsic value 614, the extrinsic value 624 may be stored in a body 621 of the data block 620 along with the user ID 612 and the content ID 613. However, in this case, both the value (e.g., extrinsic value 624) and the timestamp 625 will be different. The extrinsic value 624 may replace the original intrinsic value 614 or it may be used to determine a combined value for the content. Similar to a security that grows over time, the user-generated content can go up or down in value based on various attributes.

Referring again to FIG. 6B, different attributes may be used to determine the extrinsic value 624 of aged content 630′. Trailing the initial process 660A may be a secondary valuation process 660B that can occur periodically that is determined at a subsequent interval of time. The secondary valuation process 660B may include an extrinsic determiner module 650 determining the extrinsic value 624 based on various factors. The extrinsic value 624 may represent a value of the content 630′ as it has grown after the content is created based on user's extrinsic value that goes up or down. A traffic determiner module 651 may determine an amount of visitors (e.g., web traffic, etc.) drawn to the site as a result of the user-generated content such as number of page reads/requests, visibility, links, likes, etc. A user reputation determiner 652 may identify a reputation of the user that posted the content 630′ which may grow over time. For example, a user's reputation may grow through peer-reviews (thumbs-up vs. thumbs-down, likes, followers, etc.) and the user should be compensated for the extrinsic value. The extrinsic determine module 650 may use any of these attributes (web traffic, reputation, etc.) to determine the extrinsic value 624. The intrinsic value 614 and the extrinsic value 624 may be financial values, coin values, token values, etc.

Although not shown in FIG. 6A, the distributed ledger which stores the blockchain 600 may also include a state database or key-value store. The most current value (e.g., intrinsic value 614, extrinsic value 624, etc.) may be stored in a key-pair with the content ID to enable a smart contract to quickly ascertain the current value of the content. This can be beneficial when the user attempts to exchange their coins/tokens with other items of value via a blockchain. The extrinsic value 624 may be updated and determined on a regular/periodic basis to keep the content value “fresh”.

For example, additional users (not shown) may exchange value with coin owners who have generated content for the website. The value may be in the form of currency, goods, services, etc. which are a valued-for exchange for the coins received from the website (i.e., interest in the website). In this case, the users exchanging other items of value may receive the coin/token and may control ownership of the corresponding “interest” in the website as a result of the exchange. Similar to a stock, a bond, etc., the coin's holder/owner may have a security interest in the website.

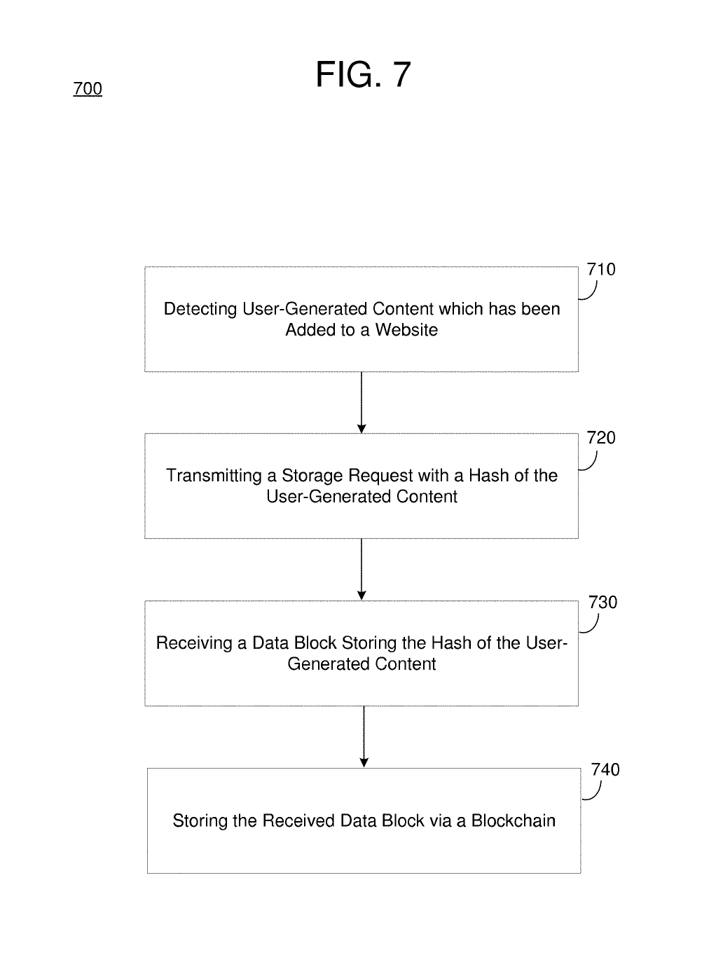

FIG. 7 illustrates a method 700 of storing user-generated content via a blockchain, in accordance with an example embodiment. For example, the method 700 may be performed by a blockchain network which includes one or more of a client, a peer node, an endorser node, and an ordering node. It should also be appreciated that the steps of method 700 may be performed by the components of the computing system 500. Referring to FIG. 7, in 710, the method may include detecting user-generated content which has been added to a website via a user device accessing the website through a connection to a host server of the website. For example, the user-generated content may be uploaded as supplemental content (e.g., review content, rating information, pictures, videos, etc.) in association with a web listing such as a vacation rental listing, or the like. In some embodiments, the detecting may include detecting one or more of images, text, and video media which are added by a user device to a website based on a network connection between the user device and a host server of the web site.

The user-generated content may be stored on a blockchain and may be exchanged for value provided by the website (e.g., an interest in the website itself, etc.) The user-generated content may be incorporated into a transaction by a client software which is stored on the user device and a transaction request may be forward from the client to one or more endorser peer nodes of the blockchain. The endorser peer nodes may endorse the transaction (including the user-generated content) and return endorsement responses to the client. In response to the transaction being endorsed by enough endorsers to satisfy an endorsement policy of the blockchain, the client may build a transaction proposal which includes the user-generated content and the endorsement responses and forward the transaction proposal to an ordering node.

In 720, the method may include transmitting a storage request (e.g., the transaction proposal, etc.) comprising a hash of the user-generated content to one or more blockchain nodes such as a blockchain peer node and/or an ordering node. In response, the ordering node may verify the endorsement responses and build a data block including multiple transactions (corresponding to multiple user-generated content entries on the website by different users) and transmit the data block to committing peer nodes of the blockchain. Here, the transactions may be ordered into a sequence based on a time in which they occurred and they may be added to the block in that order/sequence. In 730, the peer nodes may receive the data block comprising an entry which includes the hash of the detected user-generated content and an identification value of the user-generated content, and in 740, the peer nodes may store the received data block in a hash-linked chain of data blocks on a distributed ledger of the blockchain.

In order to create an immutable record where each data block on the blockchain points to a previous data block, the received data block may further include a hash value generated based on content stored within a previous data block on the hash-linked chain of data blocks. The hash value may include a hash of a header of the previous data block. As mentioned above, in some embodiments, the method may further include transmitting the user-generated content to one or more endorser nodes for consensus-based endorsement among the one or more endorser nodes. In some embodiments, the transmitting may include transmitting the storage request to an orderer node in response to a consensus among the one or more endorser nodes. In some embodiments, the method may further include updating a user interface of the user device to include a value based on the storing of the received data block. For example, a wallet or other digital account holder may be modified to indicate storage of value in the website as a result of the user-generated content being added.

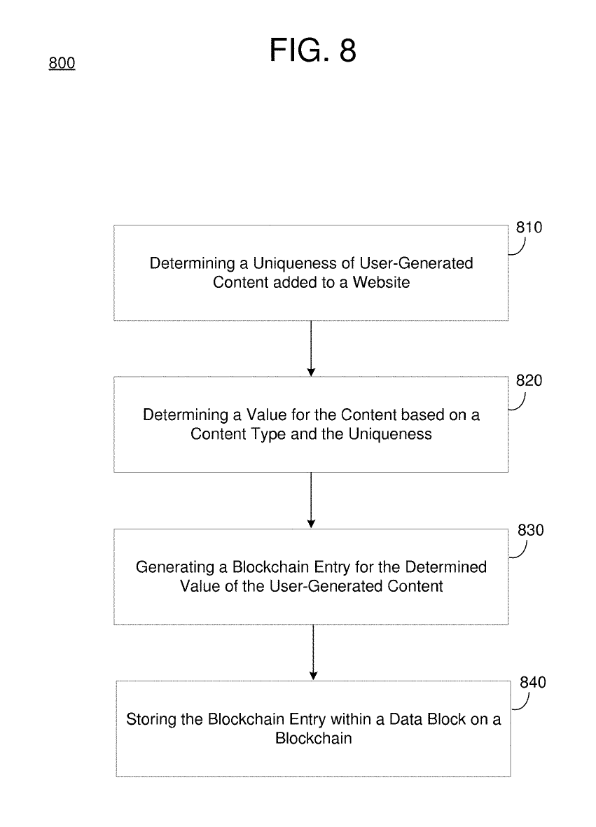

FIG. 8 illustrates a method 800 of storing a value for user-generated content via a blockchain, in accordance with an example embodiment. For example, the method 800 may be performed by a blockchain network that includes one or more of a client, a peer node, an endorser node, an orderer node, and the like. Referring to FIG. 8, although not shown, the method may include receiving or otherwise detecting user-generated content that has been added to a website. In 810, the method may include determining a uniqueness of the content that has been generated and added to the website. Here, the content may be added by a user device to a website hosted by a host server.

In 820, the method may include determining a value for the content based on a content type of the content and the determined uniqueness of the content. In some embodiments, the determining the uniqueness may include determining whether the content has been previously added to a different website. As an example, different values may be assigned to image content, text content, and video content, respectively. In some embodiments, the method may further include determining computing resources that were consumed by the user device when generating the content, and the value is further determined based on the determined computing resources consumed.

In 830, the method may include generating a blockchain entry based on the determined value for the content and the determined uniqueness of the content. For example, the blockchain entry may include a transaction that is sent to one or more endorser nodes for verification/endorsement. In response, the endorser nodes may verify the transaction and transmit endorsement response. The transaction and the endorsement responses may be forwarded as a transaction proposal to an ordering node. The ordering node may order the transaction along with other transactions (of other users that have added user-generated content to the website) in the sequence in which they were received and create a data block. Here, the transactions may be ordered into a list or other order based on a time in which they occurred.

The ordering node may transmit the generated block to one or more committing peer nodes of the blockchain. Accordingly, in 840 the method may include storing the blockchain entry within a data block included among a hash-linked chain of data blocks.

Although the examples are described herein as being associated with mining a website. It should be appreciated that the example embodiments are also applicable to other online services. For example, the system described herein may be used to mine a mobile application instead of a website. In this example, user-generated content may be added to the mobile application pages that are shared among different users. In response, the user may receive value such as coins, and the information may be stored and tracked via blockchain.

In some embodiments, the value of the user-generated content may change as it ages or as the user's reputation changes. For example, the method may further include performing a modification to the value for the content based on traffic to the website associated with the content, and storing the modified value via a data block among the hash-linked chain of data blocks. In some embodiments, the method may include performing a modification to the value for the content based on a change in reputation of a user associated with the user device that generated the content, and storing the modified value via a data block among the hash-linked chain of data blocks. In some embodiments, the blockchain entry may further include a digital token that is mined via addition of the content to the website.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to detect user-generated content added to a website via a user device accessing the website through a connection to a host server of the website; and
a network interface configured to transmit a storage request comprising a hash of the user-generated content which has been added, and receive a data block comprising an entry which includes the hash of the detected user-generated content and an identification value of the user-generated content,
wherein the processor is further configured to store the received data block in a hash-linked chain of data blocks.

2. The computing system of claim 1, wherein the processor is configured to detect one or more of images, text, and video media which are added to the website by the user device via the connection to the host server.

3. The computing system of claim 1, wherein the received data block further comprises a hash value generated based on content stored within a previous data block on the hash-linked chain of data blocks.

4. The computing system of claim 1, wherein the network interface is further configured to transmit the user-generated content to one or more endorser nodes for consensus-based endorsement among the one or more endorser nodes.

5. The computing system of claim 4, wherein the network interface is configured to transmit the storage request to an orderer node in response to a consensus among the one or more endorser nodes.

6. The computing system of claim 1, wherein the data block is stored in the hash-linked chain of data blocks which are recorded on an immutable blockchain ledger.

7. The computing system of claim 1, wherein the processor is further configured to update a user interface of the user device to include a value based on the storing of the received data block.

8. A method comprising:
detecting user-generated content which has been added to a website via a user device accessing the web site through a connection to a host server of the web site;
transmitting a storage request comprising a hash of the user-generated content;
receiving a data block comprising an entry which includes the hash of the detected user-generated content and an identification value of the user-generated content; and
storing the received data block in a hash-linked chain of data blocks.

9. The method of claim 8, wherein the detecting comprises detecting one or more of images, text, and video media which are added to the website by the user device via the connection to the host server.

10. The method of claim 8, wherein the received data block further comprises a hash value generated based on content stored within a previous data block on the hash-linked chain of data blocks.

11. The method of claim 8, wherein the method further comprises transmitting the user-generated content to one or more endorser nodes for consensus-based endorsement among the one or more endorser nodes.

12. The method of claim 12, wherein the transmitting comprises transmitting the storage request to an orderer node in response to a consensus among the one or more endorser nodes.

13. The method of claim 1, wherein the data block is stored in the hash-linked chain of data blocks which are recorded on an immutable blockchain ledger.

14. The method of claim 1, further comprising updating a user interface of the user device to include a value based on the storing of the received data block.

15. A non-transitory computer-readable medium comprising instructions which when executed by a processor cause a computer to perform a method comprising:
detecting user-generated content which has been added to a website via a user device accessing the web site through a connection to a host server of the web site;
transmitting a storage request comprising a hash of the user-generated content;
receiving a data block comprising an entry which includes the hash of the detected user-generated content and an identification value of the user-generated content; and
storing the received data block in a hash-linked chain of data blocks.

16. The non-transitory computer-readable medium of claim 15, wherein the detecting comprises detecting one or more of images, text, and video media which are added to the website by the user device via the connection to the host server.

17. The non-transitory computer-readable medium of claim 15, wherein the received data block further comprises a hash value generated based on content stored within a previous data block on the hash-linked chain of data blocks.

18. The non-transitory computer-readable medium of claim 15, wherein the method further comprises transmitting the user-generated content to one or more endorser nodes for consensus-based endorsement among the one or more endorser nodes.

19. The non-transitory computer-readable medium of claim 18, wherein the transmitting comprises transmitting the storage request to an orderer node in response to a consensus among the one or more endorser nodes.

20. The non-transitory computer-readable medium of claim 15, wherein the data block is stored in the hash-linked chain of data blocks which are recorded on an immutable blockchain ledger.
